(19) United States
(12) Patent Application Publication
(10) Pub. No.: US 2020/0279202 A1
(43) Pub. Date: Sep. 3, 2020

(54) CONSTRUCTION PROJECT MANAGEMENT

(71) Applicant: A.C. PAZ CONSTRUCTION INC., Toronto (CA)

(72) Inventors: Alexandre CALINSKY PAZ, Toronto (CA); Bruno LIMA CALINSKY PAZ, Toronto (CA); Fernando LIMEIRA, Toronto (CA); Guilherme TROVO, Toronto (CA); Paula Edna LIMA CALINSKY PAZ, Toronto (CA); Rodrigo GOULART, Toronto (CA); Glauber NASCIMENTO, Toronto (CA); Cristian Douglas DOS REIS MADRID, São Paulo (BR); Daniel Costa COSTA GIMENES, São Paulo (BR)

(21) Appl. No.: 16/805,646

(22) Filed: Feb. 28, 2020

Related U.S. Application Data
(60) Provisional application No. 62/811,894, filed on Feb. 28, 2019.

(51) Int. Cl. G06Q 10/06; H04W 12/06; H04W 4/029

(52) U.S. Cl. CPC G06Q 10/06313; G06Q 10/063118; G06Q 50/08; H04W 12/06; H04W 4/029; G06Q 10/06316

(57) ABSTRACT

An example of an apparatus to manage a construction project is provided. The apparatus includes a communications interface to communicate with a plurality of portable electronic device. The communications interface is to transmit a job request to the plurality of portable electronic devices and to receive a plurality of responses to the job request. Each response of the plurality of responses includes an identifier and a resource request. The apparatus also includes a memory storage unit to store the job request and the plurality of responses. The memory storage unit is to maintain a database of resources. In addition, the apparatus includes a matching engine to select a response from the plurality of responses based on the database of resources. The apparatus further includes an assignment engine to transmit, via the communications interface, an acceptance of the response selected by the matching engine.

### FIELD

The present invention relates generally to the construction industry and, in particular, to managing construction projects.

### BACKGROUND

The construction industry has seen many challenges arise in the modern era due to several factors. With increasing populations, the demand for both residential and commercial structures is also ever-increasing. Time frames for jobs to be completed are thus tight and the risk of delays is high due to errors being made. Managing relationships between numerous skilled workers and tradesmen can prove to be immensely difficult, as can the management of resources such as building materials and tools.

### BRIEF DESCRIPTION OF DRAWINGS

Reference will now be made, by way of example only, to the accompanying drawings in which:

FIG. 1 is a block diagram of an example apparatus to manage a construction project;

FIG. 2 is a block diagram of a portable electronic device to be used at a worksite of a construction project;

FIG. 3 is a representation of an example system to manage a construction project;

FIG. 4 is a block diagram of another example apparatus to manage a construction project;

FIG. 5 is a block diagram of another example apparatus to manage a construction project;

FIG. 6 is a flowchart of an example method of managing a construction project;

FIG. 7 is a screenshot of the home page of a construction project management application;

FIG. 8 is a screenshot of an announcements section from a home page of a construction project management application;

FIG. 9 is a screenshot of a corporations section from a home page of a construction project management application;

FIG. 10 is a screenshot of a categories section of a construction project management application;

FIG. 11 is a screenshot of a clients section from a home page of a construction project management application;

FIG. 12 is a screenshot of a system configuration section from a home page of a construction project management application;

FIG. 13 is a screenshot of a construction site section from a home page of a construction project management application;

FIG. 14 is a screenshot of an employees section from a home page of a construction project management application;

FIG. 15 is a screenshot of a materials section from a home page of a construction project management application;

FIG. 16 is a screenshot of a timesheet section from a home page of a construction project management application;

FIG. 17 is a screenshot of a order page from a home page of a construction project management application;

FIG. 18 is a screenshot of a refund request section from a home page of a construction project management application;

FIG. 19 is a screenshot of a tool ordering section from a home page of a construction project management application;

FIG. 20 is a screenshot of a job request section from a home page of a construction project management application;

FIG. 21 is a screenshot of a schedule section from a home page of a construction project management application;

FIG. 22 is a screenshot of a users page from a home page of a construction project management application; and

FIG. 23 depicts a user setting page in a construction project management system.

### DETAILED DESCRIPTION

There is provided an apparatus and a system for managing a construction project and to assign and allocate jobs or tasks based on responses to a job request. The system may include a communication interface, a memory storage unit to store information, a matching engine to match a request with a response, and an assignment engine to transmit assignments to matched responses.

In an example, the system for construction project management may centralize and manage projects in real-time. The system may include various interfaces designed for users to interact with in relation to various criteria. These criteria may include announcements, such as job requests which may include details such as various corporations involved with a project, categories of work to be done, and clients requesting the overall project. The system may also be configurable to include different options to allow users and administrators to vary the amount of control over certain aspects of the project. The apparatus and system may also include monitoring and tracking features to collect data as well as control access to work sites at which construction is being carried out, to monitor time and access of employees and contractors of a company, to manage material inventory and orders, to manage tools, to schedule resources, and to manage and update the budget of the project. It is to be appreciated that access to different features of the system may be dependent upon the seniority or level of the user and that each user may be grouped into various groups of users with common rights.

An example method of managing jobs which are part of a construction project may involve sending a job request to a portable electronic device, wherein the job request, receiving a response to the request from the portable electronic device, wherein the response may include a request for resources, matching available resources in a database with the request, deploying the available resources, and updating the database. The resources are not particularly limited and may include, but are not limited to, people, tools, building materials, and vehicles. The database may also be accessed via a wide area network in some examples, or it may be maintained on a server, such as a separate dedicated data server. Matching of requests and responses may carried be out using a computer processor, or another separate machine.

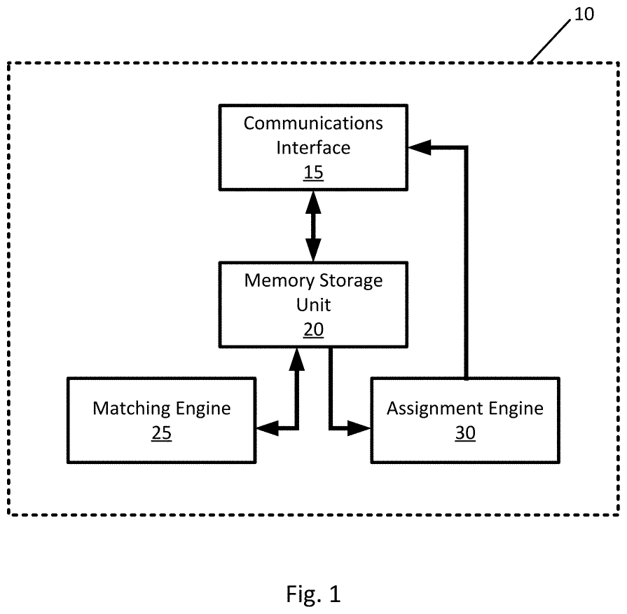

Referring to FIG. 1, a schematic representation of an apparatus to manage a construction project is generally shown at 10. The apparatus 10 may include additional components, such as various additional interfaces and/or input/output devices such as indicators to interact with an administrator of the apparatus 10. The interactions may include viewing the operational status of the apparatus 10 and associated portable electronic devices in communication with the apparatus 10, modifying the operation of the apparatus 10, or resetting the apparatus 10. In the present example, the apparatus 10 is to generally broadcast job requests and to match responses based on various criteria. In the present example, the apparatus 10 includes a communications interface 15, a memory storage unit 20, a matching engine 25, and an assignment engine 30.

The communications interface 15 is to communicate with portable electronic devices connected to a network. The exact number of portable electronic devices with which the communications interface 15 communicates is not limited. In addition, the portable electronic devices may be connected via different networks accessible by the communications interface 15. In the present example, a job request is to be transmitted to the portable electronic devices via the communications interface 15. The communications interface 15 is further to receive responses to the job request from the portable electronic devices. The responses are not particularly limited and may include various information such as an identifier of the specific portable electronic device from which the response was generated as well as a resource request to complete the job request.

As an example, it may be assumed that a job request is to excavate an area for a building foundation. Accordingly, the job request may be transmitted by the apparatus 10 to portable electronic devices associated with employees, such as a managers, or contractors. In some examples, the job request may be directed at pre-qualified employees or contractors or may be generally broadcasted. Upon receiving the job request, interested parties may transmit a response from their associated portable electronic device with information which may include a request for resources to complete the job. The resources available are not particularly limited and may include consumable supplies, building material, laborers, tradespeople, and construction equipment. Continuing with this example, a response may include a request for an excavator and five laborers. For this job request, another portable electronic device may respond to the job request with separate response requesting only five laborers without any equipment. It is to be understood that the second request may be from a contractor having its own equipment and thus may not require the use of an excavator.

The manner by which the communications interface 15 transmits and receives data is not particularly limited. In the present example, the apparatus 10 may connect to devices via a network link. Accordingly, the communications interface 15 may be a network interface communicating over the Internet. In other examples, the communication interface 15 may directly connect to the devices via a wire or other direct communication link, such as via a local area network, when the portable electronic devices are to be confined to a limited geographical area. It is to be appreciated by a person of skill with the benefit of this description that by limiting the area where the portable electronic device may operate can be used to limit the responses to employees or contractors that are on site or near the site.

The memory storage unit 20 is to store data, such as the job request and the details of the job request as well as responses associated with the job request. Furthermore, the memory storage unit 20 may maintain a database of resources. The database of resources is not particularly limited and may include information, such as inventory information or availability information, for each resource. In particular, for a consumable resource, such as building material, the database of resources may include an inventory of the resource, which may be updated as the resource is allocated. In another example, for a reusable resource, such as equipment or labor, the database of resources may manage an availability calendar for the resource.

The memory storage unit 20 may be also used to store additional data to be used by the apparatus 10. For example, the memory storage unit 20 may store additional details about a project, such as the work site location, design plans, authorized workers, etc. It is to be appreciated by a person with skill with the benefit of this description that the memory storage unit 20 may store the data in separate databases on the same physical computer readable medium in the present example. In other examples, the memory storage unit 20 may be separate and located remotely on one or more external servers, such as in a central data server or a cloud server.

In the present example, the memory storage unit 20 is not particularly limited and may include a non-transitory machine-readable storage medium that may be any electronic, magnetic, optical, or other physical storage device. The memory storage unit 20 may be used to store information such as responses received from the portable electronic devices via the communications interface 15, as well as results from the matching engine 25 or the assignment engine 30 discussed in more detail below. In addition, the memory storage unit 20 may be used to store instructions for general operation of the apparatus 10. In particular, the memory storage unit 20 may store an operating system that is executable by a processor to provide general functionality to the apparatus 10, for example, functionality to support various applications. The memory storage unit 20 may additionally store instructions to operate the matching engine 25 and the assignment engine 30. Furthermore, the memory storage unit 20 may also store control instructions to operate other components and peripheral devices of the apparatus 10.

The memory storage unit 20 may be preloaded with data and instructions or the data and instructions may be loaded via the communications interface 15 or by directly transferring the instructions from a portable memory storage device connected to the apparatus 10, such as a memory flash drive.

The matching engine 25 is to select a response received from the portable electronic devices base on the information received in the response and compared with information in the memory storage unit 20, such as the database of resources. The manner by which the matching engine 25 makes the selection is not particularly limited. For example, the matching engine 25 may optimize the use of the resources available by matching a response having a lower amount of resources requested. It other examples, the matching engine 25 may select the first response with a resource request that may be granted based on the resources available based on the information in the database of resources in the memory storage unit 20. In another example, the matching engine 25 may select a response with the lowest quote, if provided. Further examples may include the matching engine 25 using a ranking system to rank the responses based on a preferred employee or contractor, or based on another metric.

In the present example, the assignment engine 30 is to transmit the acceptance of the response selected by the matching engine 25 to the portable electronic device associated with the response. The manner by which the acceptance is transmitted is not particularly limited. For example, the identifier in the response may be used to identify a portable electronic device, such as by with a phone number or IP address. The acceptance may also include additional information such as an allocation of resources based on the resource request from the response from the portable electronic device. Upon allocating the resources, the assignment engine 30 may update database of resources on the memory storage unit 20 by reducing the amount of resources that have been allocated in the acceptance. It is to be appreciated that the resource request may not be completely fulfilled in the acceptance. In some examples, the acceptance may be a counteroffer to the selected response to determine if the portable electronic device submitting the response may complete the job with fewer resources.

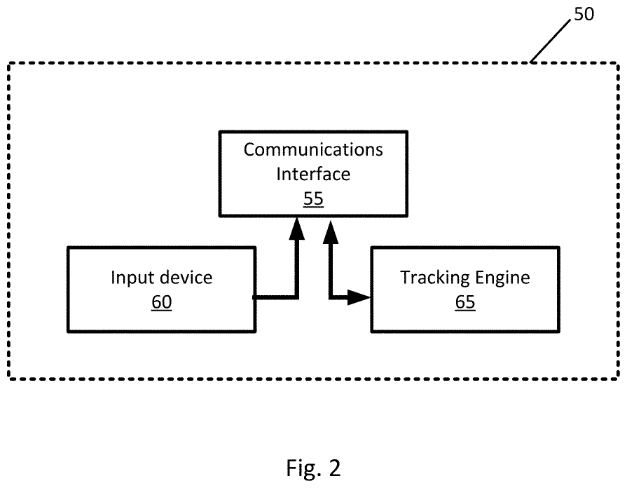

Referring to FIG. 2, an example of a portable electronic device 50 to work in cooperation with the apparatus 10 at a work site of a construction project is generally shown. The portable electronic device 50 may include additional components, such as various interfaces to communicate with other devices, and further input and output devices to interact with a user or account holder associated with the portable electronic device 50. In the present example, the portable electronic device 50 may be any type of electronic device capable of receiving job requests from the apparatus 10 and generating responses to transmit back to the apparatus 10. For example, the portable electronic device 50 may be a smartphone, a tablet, a laptop, or a desktop computer. The responses to a job request may be generated using an automated process such as by automatically responding to all job requests having predetermined criteria. In other examples, the job request may be presented to a user via an output device, such as a touchscreen, to prompt the user to enter a response. The portable electronic device 50 includes a communications interface 55, an input device 60, and a tracking engine 65.

The communications interface 55 is to communicate with a central server on a network, such as the apparatus 10. The manner by which the communications interface 55 receives and sends data is not particularly limited. In the present example, the communications interface 55 performs similar functions in the portable electronic device 50 as the communications interface 15 performs in the apparatus 10. The data exchanged via the communications interface 55 is also not particularly limited and may include receiving a job request and transmitting a response to the job request which may include an identifier associated with the portable electronic device 50 as well as information pertaining to the job request, such as a request for resources.

In the present example, the input device 60 is to receive input from a user, which may include input used to generate a response to a job request from the apparatus 10. The response is not particularly limited and may be transmitted from the portable electronic device 50 to the apparatus 10 via the communications interface 55. It is to be appreciated that the specific type of user input received via the input device 60 and is not particularly limited. For example, the input device 60 may be a device to interact with a human user, such as a keyboard, a pointer device, a touch sensitive device, a button, a microphone, or any other device to generate control signals in response to the actions of a user. In further examples, the user input device 60 may be the touch sensitive portion of a display disposed on the portable electronic device 50 to provide a touchscreen interface where the job request may be presented to the user who may in turn interact with the job request to generate a response. Furthermore, the input device 60 may be used to enter additional information or resource requests. Upon completion of the job, the input device 60 may be used to enter reports and submit further documentation such as expenses associated with the job for approval.

In some examples, the user input device 60 may be another communications interface to communicate with a connected device or a network, such as the Internet, where user input may be received from another electronic device. For example, the portable electronic device 50 may be connected to a peripheral device, such as a smartwatch, another smartphone or another type of device which may be used to provide the control commands for the portable electronic device 50.

The tracking engine 65 is to monitor the portable electronic device for entry into a work site as well as for an exit from the worksite. In particular, the entry and exit of the portable electronic device 50 may be logged and data may be transmitted to a central server, such as the apparatus 10 automatically. Accordingly, the data collected by the tracking engine 65 may be used to measure the working hours of the user associated with the portable electronic device 50 and used to generate time sheets to track the time. It is to be appreciated by a person of skill that in circumstances where the resource for carrying out a job request includes the user of the portable electronic device, the tracking engine 65 may be used to quantify the amount of time used for the project.

The manner by which the tracking engine 65 identifies an entry or exit from a work site is not particularly limited. In an example, the tracking engine 65 may receive a user input via the input device 60 for self identification of an entry or exit by the user. In other examples, the portable electronic device 50 may include sensors to detect the entry or exit from a work site using near field communication technology or RFID technology. In further examples, the tracking engine 65 may also track the movement of the portable electronic device 50 within a worksite to ensure the the user is in an authorized area as well as for locating the user at any given time.

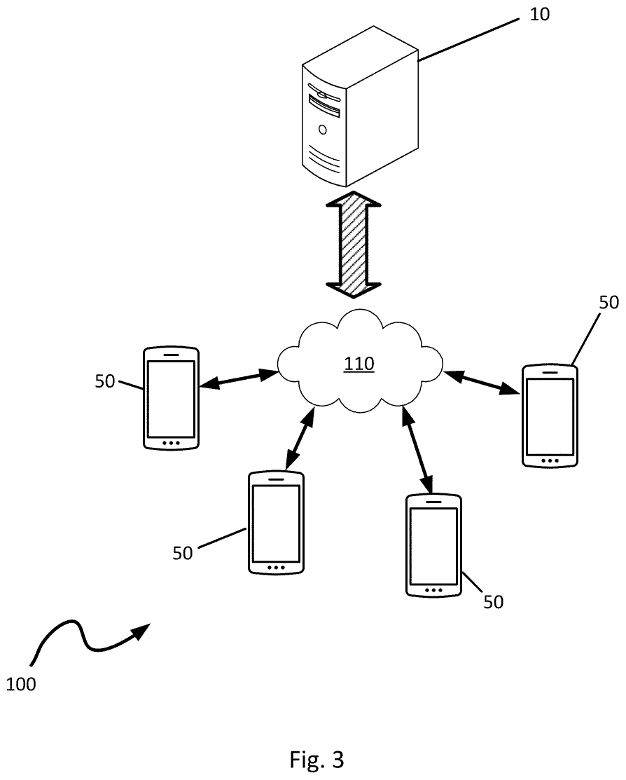

Referring to FIG. 3, an example of a system 100 to manage a construction project is generally shown. In the present example system 100, the apparatus 10 is in communication with a plurality of portable electronic devices 50 via a network 110. In this example, each portable electronic devices 50 is connected to the apparatus 10. It is to be appreciated by a person of skill that the network 110 is not particularly limited and may be any wired or wireless network connecting the portable electronic devices 50 to the apparatus 10. For example, the network 110 may be the Internet to connect the portable electronic devices 50 and apparatus 10. In other examples, the network 110 may be an intranet or other type of closed and/or private network. In the present example, the apparatus 10 may transmit a job request to the portable electronic devices 50. Each portable electronic device 50 may subsequently respond to the job request as described in more detail below.

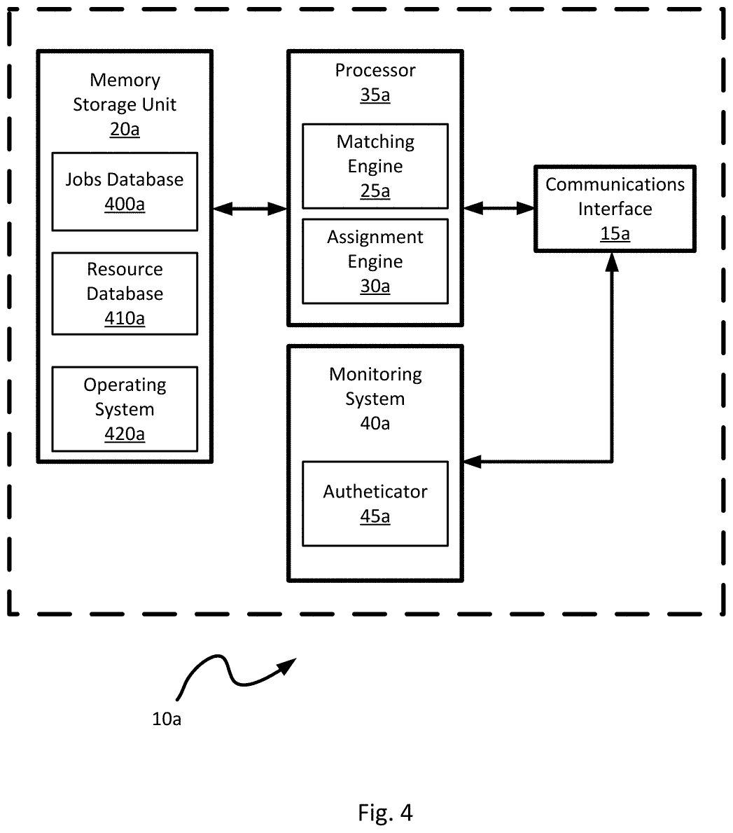

Referring to FIG. 4, another example of an apparatus to manage a construction project is generally shown at 10a. Like components of the apparatus 10a bear like reference to their counterparts in the apparatus 10, except followed by the suffix “a”. The apparatus 10a includes a communications interface 15a, a memory storage unit 20a, a processor 35a, and a monitoring system 40a. In the present example, a matching engine 25a and an assignment engine 30a are implemented by the processor 35a. Furthermore, the monitoring system 40a may include an authenticator 45a. In other examples, the monitoring system 40a may also be implemented by the processor 35a instead of as a separate stand-alone component of the apparatus 10a as shown in FIG. 4.

The processor 35a may include a central processing unit (CPU), a graphics processing unit (GPU), a microcontroller, a microprocessor, a processing core, a field-programmable gate array (FPGA), an application-specific integrated circuit (ASIC), or similar. The processor 35a and the memory storage unit 20a may cooperate to execute various instructions. In the present example, the processor 35a may execute instructions stored on the memory storage unit 20a to implement the matching engine 25a and the assignment engine 30a. In other examples, the matching engine 25a and the assignment engine 30a may each be executed on a separate processor. In further examples, the matching engine 25a and the assignment engine 30a may be operated on a separate machine, such as from a software as a service provider or in a virtual cloud server.

The memory storage unit 20a is to store various data and information on the apparatus 10a. The components of the memory storage unit 20a are not particularly limited. For example, the memory storage unit 20a may include a non-transitory machine-readable storage medium that may be, for example, an electronic, magnetic, optical, or other physical storage device. In addition, the memory storage unit 20a may store an operating system 420a that is executable by the processor 35a to provide general functionality to the apparatus 10a. The memory storage unit 20a may additionally store instructions to carry out operations at the driver level as well as other hardware drivers to communicate with other components and peripheral devices of the apparatus 10a.

In the present example, the memory storage unit 20a may also include a jobs database 400a for storing various jobs associated with a construction project. It is to be appreciated that the jobs are not particularly limited and that a construction project may be divided into a plurality of jobs in any suitable manner to divide the project among various potential employees or contractors. The jobs database 400a may store information associated with each job. For example, the jobs database 400a may include information such as timelines for completion, budgets, materials to be used, as well as whether a job is related to another job, such that completion of one job is a prerequisite for the beginning of the other job. The jobs database 400a may also include information regarding the status of a job, such as whether it has been assigned, is currently pending, completed, or partially completed. Furthermore, the jobs database 400a may also include a list of preferred employees or contractors or a blacklist of employees and contractors that are not permitted to be awarded the job.

During the management of the construction project, the processor 35a may periodically review the jobs in the jobs database 400a that are still pending. The processor 35a may generate a job request based on the information in the jobs database 400a. The job request may then be broadcasted via the communications interface 15a to a plurality of portable electronic devices 50. Furthermore, it is to be appreciated by a person of skill with the benefit of this disclosure that the jobs database 400a may be used to generate various reports to provide an overview of the construction project as a whole. For example, payment reports, schedules, financial reports, projections and other data associated with the project may be generated based from the jobs database 400a. Information relating to costs, such as invoices and receipts, may also be uploaded to store in the jobs databased 400a for subsequent accounting.

In addition, the memory storage unit 20a may include a resource database 410a. The resource database 410a is not particularly limited and may include information, such as inventory information or availability information, for each resource. In particular, for a consumable resource, such as building material, the resource database 410a may include an inventory of the resource, which may be updated as the resource is allocated. In another example, for a reusable resource, such as equipment or labor, the resource database 410a may manage an availability calendar for the resource. Accordingly, the matching engine 25a may refer to the resource database 410a prior to selecting a response to a job request. In particular, the matching engine 25a may verify that sufficient resources are available to satisfy the response to the job request and may select a different response requesting fewer resources if there are not sufficient resources to the allocated.

The monitoring system 40a is to monitor a resource upon allocating the resource to a job. The type of resource to be monitored by the monitoring system 40a is not particularly limited. For example, the monitoring system 40a may track the delivery of building materials such as lumber to a worksite. In other examples, the monitoring system 40a may be used to track a person, such as a laborer, with a tracking device at a work site. By tracking the laborer, it may be used to monitor the productivity of the laborer or allow for quick locating and redeployment of the laborer at the work site. For example, productivity may be inferred from the location of the laborer within the worksite by determining if the assigned job is intended to be carried out at a specific location. If the laborer is to unload materials, the movement tracking with the work site may provide an indication of the speed and efficiency of how the laborer is carrying out the job. Furthermore, the monitoring system 40a may track an entry of the tracking device and an exit of the tracking device from the work site. It is to be appreciated that this functionality may replace traditional time stamping to track the amount of time that a person remains within a work site as well as provide an accurate count of the number of people within a worksite. The tracking of time may be used to calculate compensation as well as to ensure compliance with local regulations requiring specific people to be at the work site. In addition, in some examples notifications or alarms may be generated when the monitoring system 40a detects movements or entries/exits that may be suspicious. Furthermore, the tracking devices may also have a notification feature where it notifies the user when a break is be taken or whether the shift is ended, such as to comply with safety regulations at some work sites.

In the present example, the monitoring system 40a may also include an authenticator 45a to verify the identity of a person with the tracking device. For example, the work site associated with a project may restrict access to authorized persons or groups of persons for security reasons. Accordingly, the tracking device may collect data about the user to the authenticator 45a where a verification of the identity is to be carried out. The data collected is not particularly limited and may include a password or passcode. In other examples, the authenticator 45a may carry out a biometric authentication process and the data collected may be a fingerprint scan, a facial scan, or a retinal scan.

The tracking device monitored by the monitoring system 40a is not particularly limited. In the present example, the tracking device may be similar to the portable electronic device 50 or the portable electronic device 50a. In particular, any smartphone, tablet, laptop, or other portable electronic device running a tracking application compatible with the apparatus 10a may be used as a tracking device. In some examples, the tracking device may include a fingerprint scanner and/or a camera to carry out a facial scan or a retinal scan to provide biometric data to the authenticator 45a.

Referring to FIG. 5, another example of a portable electronic device 50a to work in cooperation with the apparatus 10 or the apparatus 10a at a work site of a construction project is generally shown. Like components of the portable electronic device 50a bear like reference to their counterparts in the portable electronic device 50, except followed by the suffix “a”. The portable electronic device 50a includes a communications interface 55a, a user input device 60a, a processor 70a, a biometric scanner 80a, a GPS receiver 85a, and a memory storage unit 90a. In the present example, a tracking engine 65a and a verification engine 75a are implemented by the processor 70a.

In the present example, the tracking engine 65a may communicate with the GPS receiver to collect positional data for the tracking engine 65a. The positional data may be used to monitor the location of the portable electronic device to provide further data relating to the user in work sites where GPS signals may be received.

The processor 70a may include a CPU, a GPU, a microcontroller, a microprocessor, a processing core, a FPGA, an ASIC, or similar. The processor 70a and the memory storage unit 90a may cooperate to execute various instructions. In the present example, the processor 70a may execute instructions stored on the memory storage unit 90a to implement the tracking engine 65a and the verification engine 75a. In other examples, the tracking engine 65a and the verification engine 75a may each be executed on a separate processor. In further examples, the tracking engine 65a and the verification engine 75a may be operated on a separate machine, such as from a software as a service provider or in a virtual cloud server. It is to be appreciated that the processor 70a may be similar to the processor 35a in some examples.

In the present example, the verification engine 75a is to authenticate a user of the portable electronic device 50a. The verification engine 75a may collect verification data from the input device 60a and/or the biometric scanner 80a for the authentication process. The verification data is not particularly limited may include a username and password or sensor data from the biometric scanner 80a. In some examples, multiple forms of verification data may be collected to carry out multifactor authentication. Once the verification data is received, the verification engine 75a may transmit the verification data to a central server such as the apparatus 10a for authentication by the authenticator 45a. In other examples, the verification engine 75a may operate locally such as for application where there may be no constant and reliable network connection to communicate with the apparatus 10a. In such examples, the verification engine 75a may authenticate locally using a local database stored on the memory storage unit 90a to provide the features and functionality of the portable electronic device 50a to the user. It is to be appreciated by a person of skill with the benefit of this description that in this example, the verification engine 75a may subsequently transmit the result of the verification along with the verification data to the apparatus 10a for record keeping and/or for a secondary authentication.

The biometric scanner 80a is not particularly limited and may be a scanner to collect any type of biometric data. For example, the biometric scanner 80a may be a fingerprint scanner to collect fingerprint data. In another example, the biometric scanner 80a may be a camera or other image capturing device to collect a retina scan of the user as verification data. The biometric scanner 80a may also be a camera to collect images and to process the image for feature recognition, such as facial recognition.

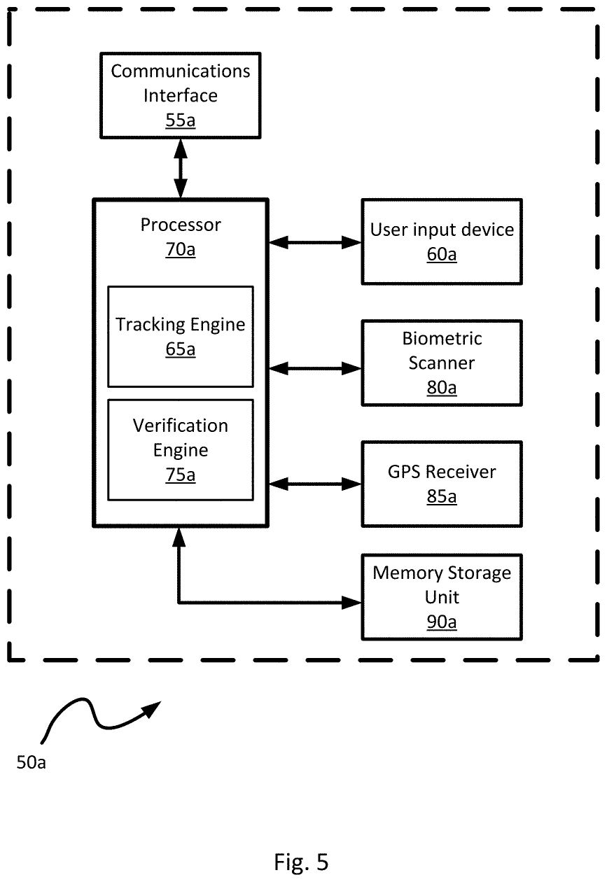

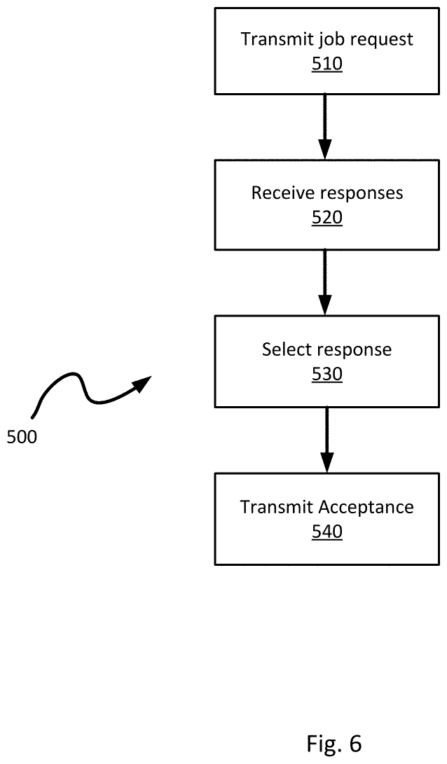

Referring to FIG. 6, a flowchart of an example method of managing a construction project is generally shown at 500. In order to assist in the explanation of method 500, it will be assumed that method 500 may be performed by the apparatus 10a and a plurality of portable electronic devices 50a. Indeed, the method 500 may be one way in which the the apparatus 10a and a plurality of portable electronic devices 50a may operate together as a system. It is to be emphasized, that method 500 may not be performed in the exact sequence as shown, and various blocks may be performed in parallel rather than in sequence, or in a different sequence altogether.

Beginning at block 510, a job request is initiated at the apparatus 10a. The job request is sent to the plurality of portable electronic devices 50a. The manner by which the job request is sent is not particularly limited and may involve broadcasting messages to portable electronic devices 50a within a specific geographical area. In other examples, a list of eligible portable electronic devices 50a for receiving the broadcasted message may be used. In the present example, the broadcasting messages may be sent via an application running on each of the portable electronic devices 50a.

Block 520 comprises receiving the job request at each portable electronic device 50a that was sent at block 510 by the apparatus 10a. Once the job request has been received, the request may be processed at the portable electronic device 50a and a response returned to the apparatus 10a. The manner by which the job request is processed is not particularly limited. For example, the job request may be displayed on a screen to a user who may manually provide input in response to various prompts. In another example, the portable electronic device 50a may have rules in place such that all job requests falling within specific criteria of the rules are to be accepted. The portable electronic device 50a may also include a database of resources in the memory storage unit 90a such that a resource request may also be generated automatically. Accordingly, the response to be returned to the apparatus 10a is to include an identifier of the portable electronic device 50a and the resource request. Each portable electronic device to provide a response will subsequently transmit the response to the apparatus 10a.

At block 530, the apparatus 10a selects a response from the multiple responses received from various portable electronic devices 50a. The selection process is not limited and involves matching a response with the job request based on the database of resources. In particular, the matching engine 25a may determine whether there are sufficient resources as tracked in the database of resources to fulfill the resource request in the response. The matching engine 25a may then apply various predetermined factors to select the response to the job request which will be accepted.

Block 540 comprises transmitting the acceptance of the response selected by the matching engine 25a at block 530. The acceptance is to be transmitted to the portable electronic device 50a that provided the response. In the present example, the response further includes the allocation of resources that is approved. The allocation of resources is made based on the resource request in the response; however, the allocation may not fulfill the entire resource request. In some examples, the database of resources may also be updated in real time as the resources are allocated by each acceptance. In other examples, the database of resources may be updated periodically, such as daily or weekly.

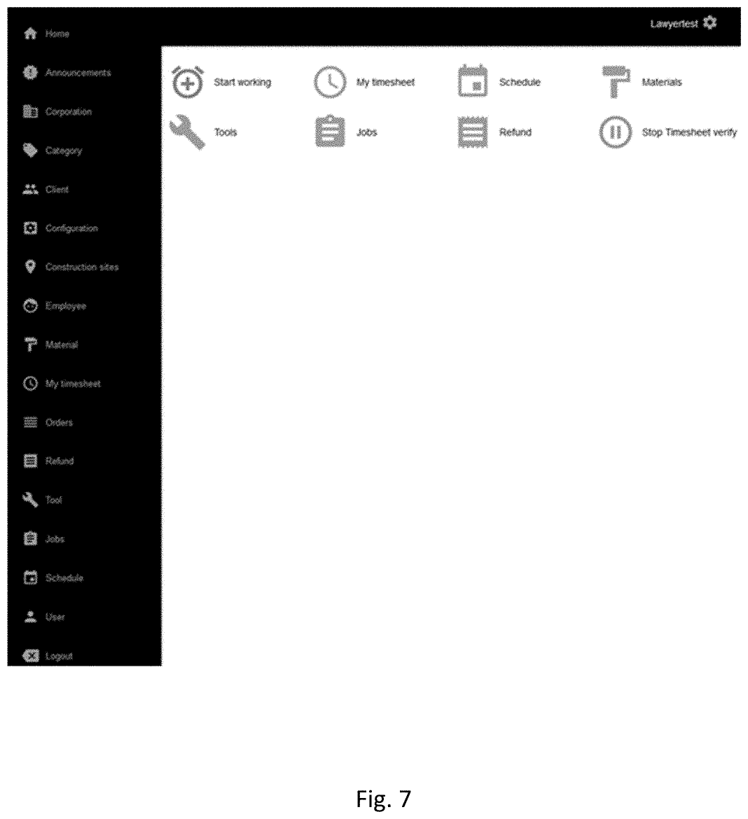

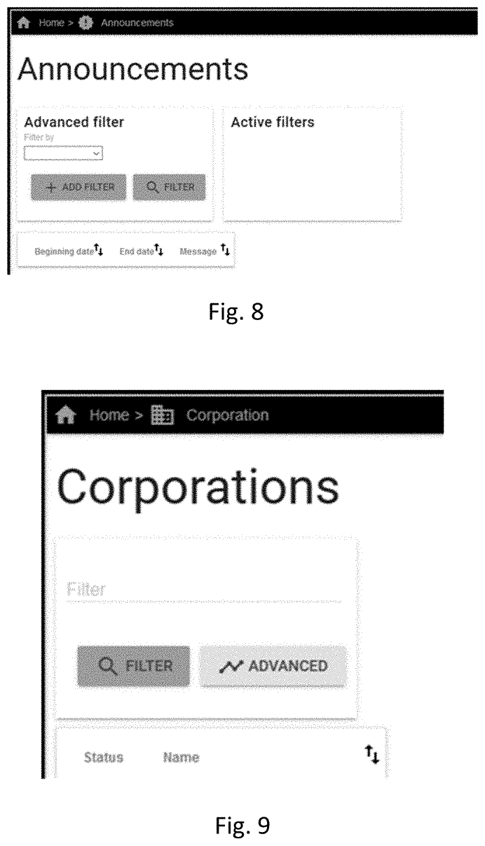

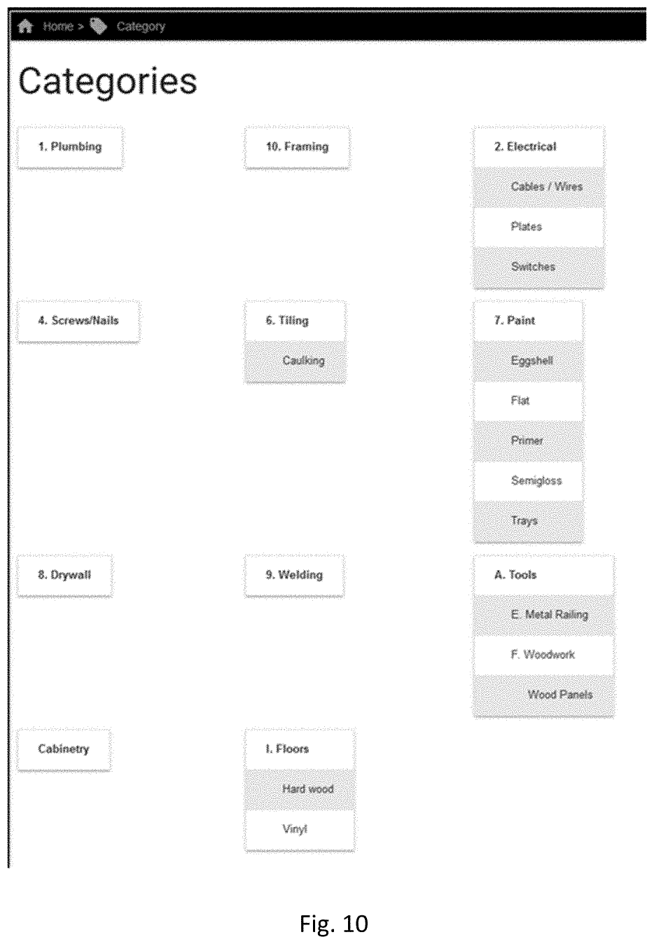

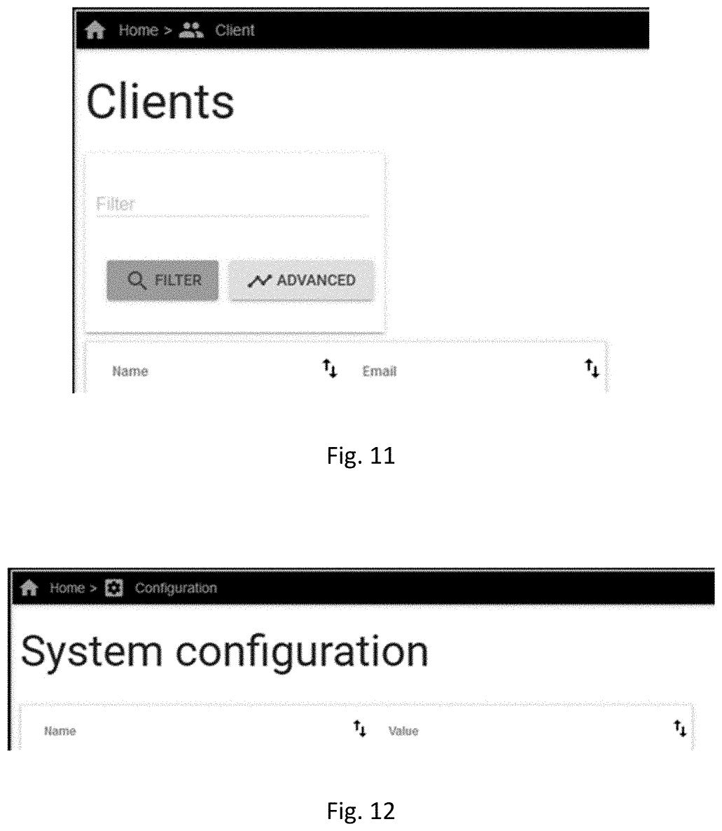

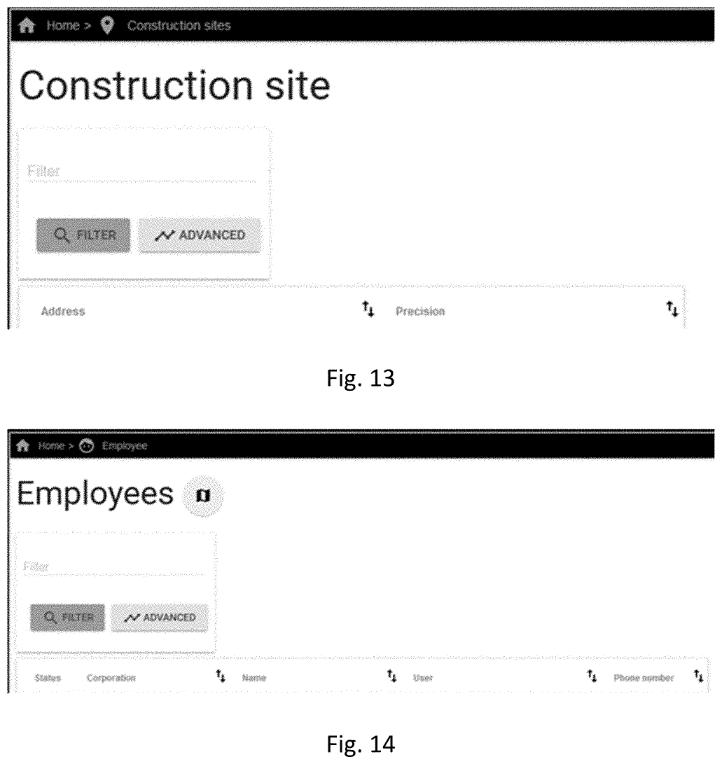

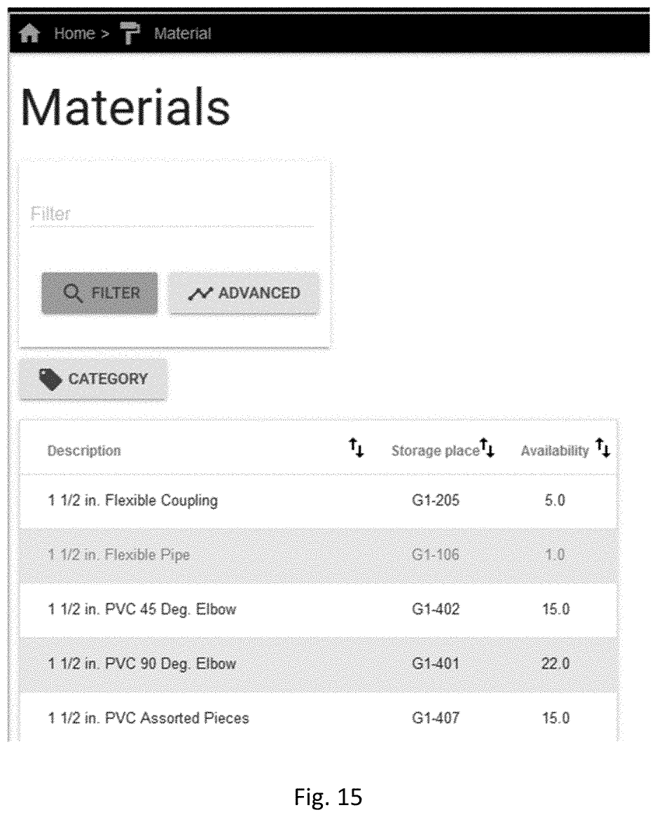

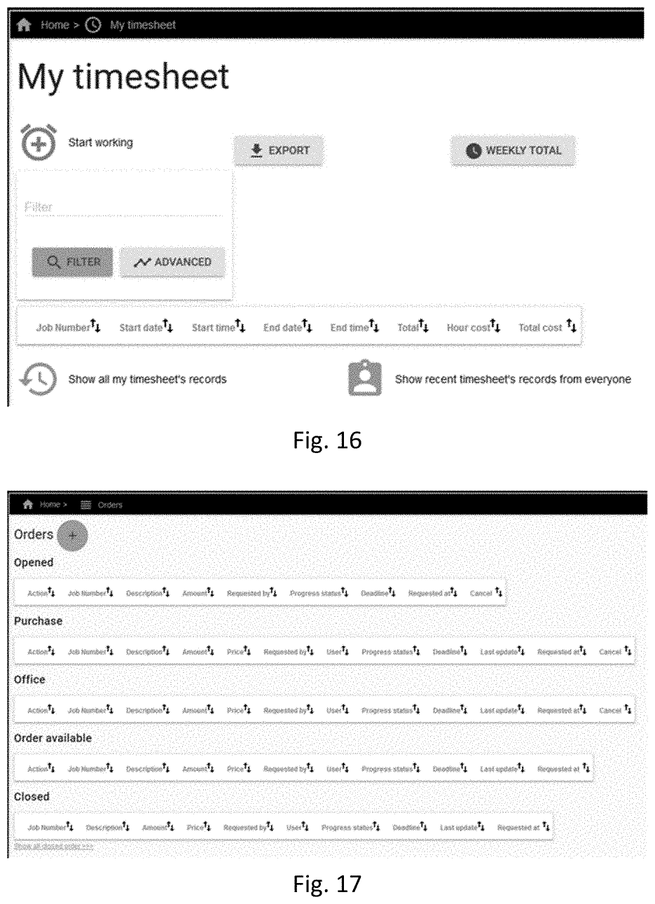

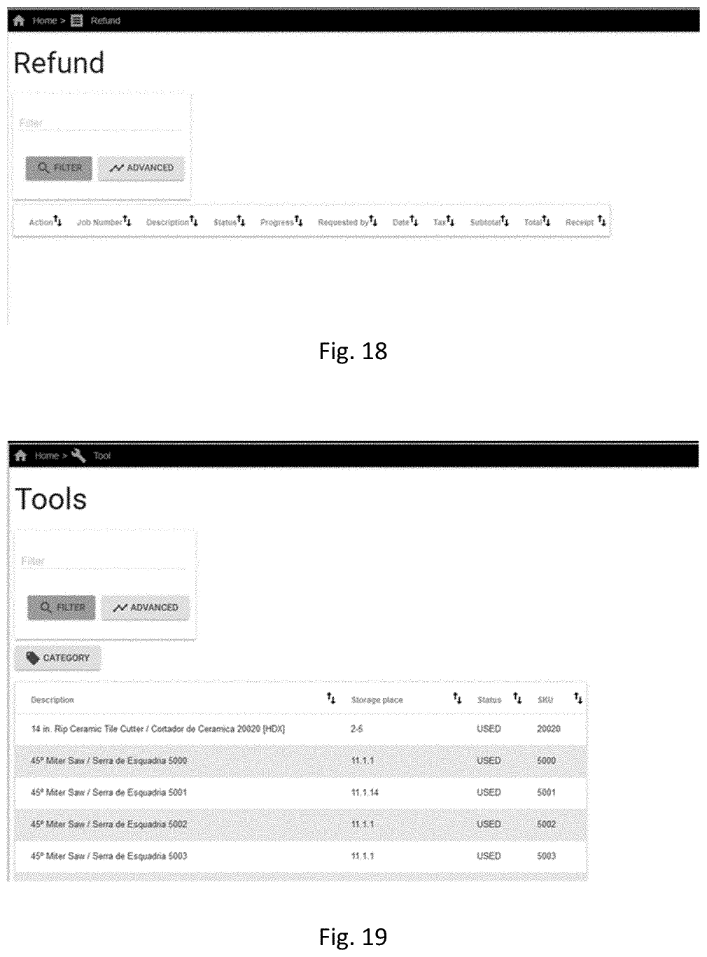

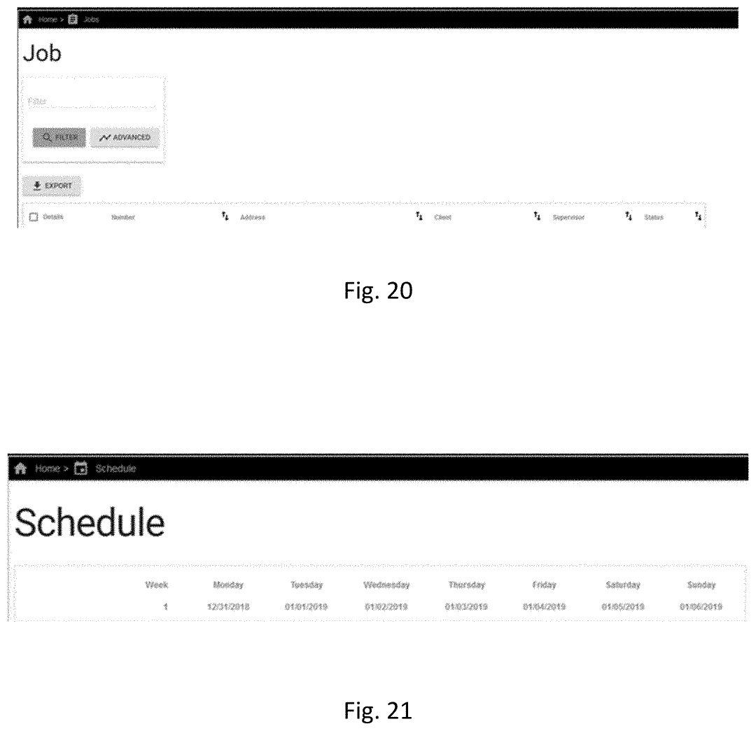

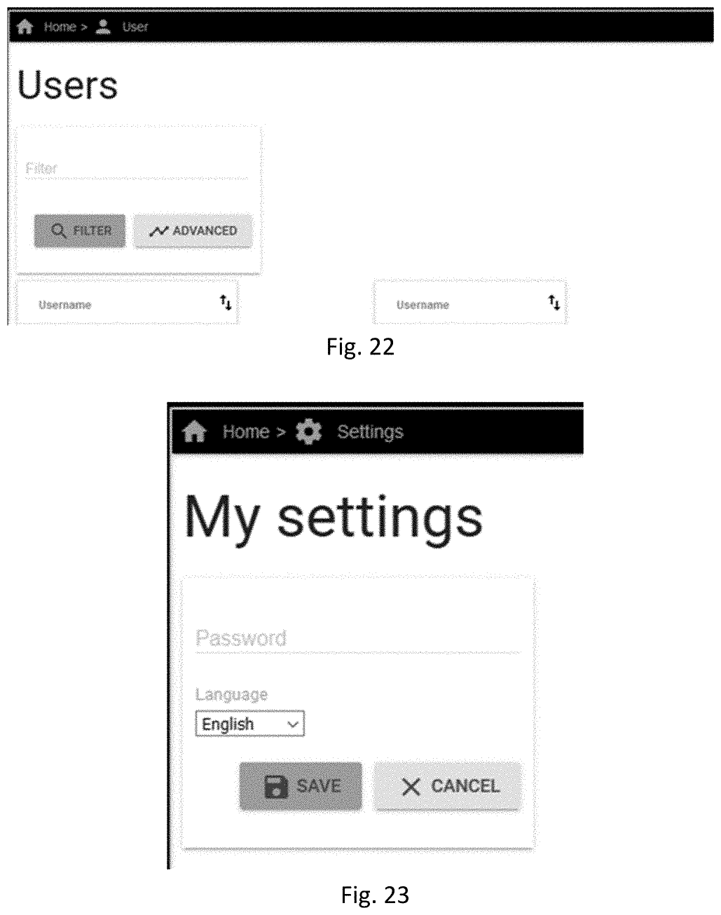

FIGS. 7 to 24 illustrate screenshots of an application carried out by the apparatus 10a. It is to be appreciated that FIGS. 7 to 24 illustrate the implementation of some of the examples described above.

The scope of the claims should not be limited by the examples set forth in the above examples but should be given the broadest interpretation consistent with the description as a whole.

What is claimed is:

1. An apparatus to manage a construction project, the apparatus comprising:
a communications interface to communicate with a plurality of portable electronic devices, wherein the communications interface is to transmit a job request to the plurality of portable electronic devices and to receive a plurality of responses to the job request, wherein each response of the plurality of responses includes an identifier and a resource request;
a memory storage unit to store the job request and the plurality of responses, the memory storage unit to maintain a database of resources;
a matching engine to select a response from the plurality of responses based on the database of resources; and
an assignment engine to transmit, via the communications interface, an acceptance of the response selected by the matching engine.

2. The apparatus of claim 1, wherein the acceptance includes an allocation of resources based on the resource request.

3. The apparatus of claim 2, wherein the assignment engine is to update the database of resources based on the resource request associated with the response selected from the plurality of responses.

4. The apparatus of claim 1, further comprising a monitoring system, wherein the monitoring system is to monitor a resource.

5. The apparatus of claim 4, wherein the resource is a person with a tracking device.

6. The apparatus of claim 5, wherein the monitoring system is to track movements of the tracking device within a work site.

7. The apparatus of claim 6, wherein the monitoring system is to track an entry of the tracking device into the work site and an exit of the tracking device from the work site.

8. The apparatus of claim 7, wherein the monitoring system includes an authenticator to verify the person with the tracking device is authorized to enter the work site.

9. The apparatus of claim 8, wherein the authenticator is to carry out a biometric authentication process.

10. A portable electronic device to be used at a work site of a construction project, the portable electronic device comprising:
a communications interface to communicate with a central server, wherein the communications interface is to receive a job request;
an input device to receive input used to generate a response to the job request, wherein the response includes an identifier and a resource request, the response to be transmitted to the central server via the communications interface; and
a tracking engine to monitor for entry into the work site and exit from the work site, wherein the tracking engine is to transmit data to the central server automatically.

11. The portable electronic device of claim 10, wherein the tracking engine is to track movement within the work site.

12. The portable electronic device of claim 11, further comprising a GPS receiver, wherein the GPS receiver is to collect positional data for the tracking engine to record movement within the work site.

13. The portable electronic device of claim 12, further comprising a verification engine to authenticate a user.

14. The portable electronic device of claim 13, wherein the verification engine is to transmit collected verification data to the central server for authentication.

15. The portable electronic device of claim 14, further comprising a biometric scanner to collect the verification data.

16. The portable electronic device of claim 15, wherein the biometric scanner is a retinal scanner.

17. The portable electronic device of claim 16, wherein the biometric scanner is a facial recognition system.

18. The portable electronic device of claim 13, wherein the verification engine is authenticate collected verification data locally and to transmit a result to the central server.

19. A method of managing a construction project, the method comprising:
transmitting a job request to a plurality of portable electronic devices;
receiving a plurality of responses to the job request from the plurality of portable electronic devices, wherein each response of the plurality of responses includes an identifier and a resource request;
selecting a response from the plurality of responses based on a database of resources, wherein the database of resources is maintained on a memory storage unit; and
transmitting an acceptance to a portable electronic device associated with the response selected from the plurality of responses.

20. The method of claim 19, further comprising allocating resources based on the resource request and updating a database of resources based on the resources allocated by the acceptance.
